(19) United States
(12) Patent Application Publication
(10) Pub. No.: US 2007/0111649 A1
(43) Pub. Date: May 17, 2007

(54) Combined air blending and air distribution actuating unit

(76) Inventors: Martin Nowak, Roesrath (DE); Michael Friedl, Pulheim (DE)

Correspondence Address: FRASER CLEMENS MARTIN & MILLER LLC, 28366 KENSINGTON LANE, PERRYSBURG, OH, 43551, US

(21) Appl. No.: 11/598,328

(22) Filed: Nov. 13, 2006

(30) Foreign Application Priority Data
Nov. 14, 2005 (DE) 102005056017.2-16

(51) Int. Cl. B60H 1/00

(52) U.S. Cl. 454/69

(57) ABSTRACT

The invention relates to a combined air blending and air distribution actuating unit for manual heating and air conditioning systems of motor vehicles with at least one heating and air conditioning device for producing a conditioned air flow, a first actuator for releasing a blended air flow path and a second actuator for releasing an air distribution flow path. The two actuators are functionally connected to each other by means of a coupling element. For controlling the air blend and air distribution actuating unit, a mechanical or electrical actuating element is provided which engages with either of the two actuators or the coupling element.

### CROSS-REFERENCE TO RELATED APPLICATION

This application claims the benefit of German application serial no. 10 2005 056 017.2-16, filed on Nov. 14, 2005.

### FIELD OF THE INVENTION

The invention relates to a combined air blending and air distribution actuating unit for heating and air conditioning systems of motor vehicles with at least one heating and air conditioning device for producing a conditioned air flow, a first actuator for releasing a blended air flow path and a second actuator for releasing an air distribution flow path.

### BACKGROUND OF THE INVENTION

Air conditioning of the passenger compartment of motor vehicles is provided not only for creating a comfortable climate for the passengers, but additionally, also to ensure free visibility through the windows, save the passengers from unpleasant odour or environmental pollution and create conditions little tiring the driver.

The indoor temperature, the indoor relative humidity, the loading of the interior by sunlight, the pollution of the interior by contaminants entering by the outdoor air as well as the outdoor temperature and air relative humidity are among the most important factors of influence on the comfort in the passenger compartment.

According to the trim level, manual, semi-automatic or fully automatic air conditioning systems are used for the air conditioning of a vehicle's passenger compartment. Semi-automatic or fully automatic air conditioning systems are characterized by that the operator only needs to enter a desired temperature via the user interface while an electronics unit computes an air outlet temperature based on the operator's input, the boundary conditions, such as the cooling water temperature and the outside temperature, and the characteristics of the air conditioning system. The control loop is closed by feedback of the actual indoor temperature. Thus, such air conditioning systems automatically control the blending ratio of hot air from the radiator and cold air from the evaporator, or the coolant valve.

While highly functional said semi-automatic or fully automatic air conditioning systems are disadvantageous in that, due to the number of electronic components and sensors, they are susceptible to faults and very expensive. Furthermore, vehicles equipped with such air conditioning systems are overequipped for some conditions of use, hence unfit.

Manual heating and air conditioning systems are a lower-cost alternative, only provided with a simple control to protect the evaporator from icing. All other functions, such as temperature choice, air distribution and fan control, are executed manually-mechanically via a control unit with control elements. Typically, the control unit includes a control element each for the fan, the air temperature, the air outlet, the interior air mode and switching-on/switching-out of the air conditioning system. To assign a desired air temperature to an individual air outlet the driver, therefore, has to operate in sequence the control element of an air outlet and the control element of the air temperature. That is awkward and may lead to that when driving alone, the driver is diverted from the drive events for a longer period of time.

From prior art, the operating device disclosed by DE 90 05 778 U1 for setting several heating and/or ventilation doors is known. A control unit with a control element is provided that is coupled to a gate guide actuatable by an electric actuating unit. The gate guide and the electric actuating unit thereof are attached to the operating device and the electric actuating unit is in electrical connection to an electrical set value input element which is in mechanical driving connection to the control element.

From DE 196 07 652 A1 a gear with a cam disc driven by only one geared motor is known for controlling the air doors of a heating and/or air conditioning system of a motor vehicle. This invention is characterized by that two tracers attach to the cams of a single cam disc, whereby the first tracer projects at a first pivotable intermediate lever which is connected to a first door over gear intermediate elements, and the second tracer projects at a second pivotable intermediate lever which is connected to a second door over gear intermediate elements.

Both inventions have in common that at the same time, two air doors, namely a footwell air door and a defrost air door, for example, are controlled by one single control element.

Further, from DE 198 09 916 A1 a control gear of a heating and/or air conditioning system of a motor vehicle with a gate disc is known which is used to control the valve used for blocking the water side of the evaporator and also a temperature door.

The objective of this invention is to propose a combined air blending and air distribution actuating unit for manually operable heating and air conditioning systems of motor vehicles, which is low-cost and makes controlling and handling, particularly temperature choice and air distribution, easier for the driver.

### SUMMARY OF THE INVENTION

According to the concept of the invention, the combined air blending and air distribution actuating unit for manual heating and air conditioning systems of motor vehicles includes at least a heating and air conditioning device for producing a conditioned air flow, a first actuator for releasing an air distribution flow path and a second actuator for releasing a blended air flow path. According to the invention, the two actuators are functionally connected to each other by a coupling element. To control the air blending and air distribution actuating unit a mechanical or electrical actuating element is provided which is engaged either with one of the two actuators or the coupling element.

So, particularly advantageously, using only one single actuating element the blended air flow path can be released and/or blocked and the air distribution flow path can be released and/or blocked at the same time so that manual control of the heating and air conditioning system of the vehicle is significantly simplified. Further, the air blending and air distribution actuating unit of the invention leads to reduced costs insofar as the second actuating element provided by prior art and, possibly, the appropriate coupling unit, which connects the actuating element to the actuator, become unnecessary. In addition, replacement and retrofitting of the air blending and air distribution actuating unit become especially easy.

In a first embodiment of the invention the actuating element is directly engaged only with the first actuator for releasing the air distribution flow path. In contrast, the second actuator is functionally connected only indirectly to the actuating element through the coupling element placed between the first actuator and the second actuator.

In a second embodiment of the invention the actuating element is directly engaged only with the second actuator for releasing a blended air flow path. In contrast, the first actuator is functionally connected only indirectly to the actuating element through the coupling element placed between the second actuator and the first actuator.

In a third embodiment of the invention the actuating element is directly engaged only with the coupling element. The first actuator and the second actuator, however, are functionally connected only indirectly to the actuating element.

The coupling element functions, first, to couple the two actuators to each other and, next, to compensate for the different actuating distances of the two actuators. In practice, a simple mechanical bar linkage or, otherwise, a gear more expensive in design is provided. Said gear is preferably designed as closed-track cam drive. The cam drive includes a cam disc pivotable on one or several axis/axes, having at least two tracks, whereby the first actuator engages with the first track, while the second actuator engages with the second track, whereby, possibly, use is made of an additional connecting element. The closed-track cam drive is placed either directly at the heating and air conditioning device or at the control unit.

If the coupling element is placed at the heating and air conditioning device, an additional coupling unit is provided to transmit signals from the actuating element to one of the two actuators or to the coupling element placed between the actuators. The coupling unit is preferably established as drive shaft, control cable, linkage, lever, actuating motor or other mechanical system preferably extending between the actuating element and one of the two actuators or the coupling element.

Both actuators are preferably established as door or as mechanical actuating system releasable steplessly and continuously between an open position and a closed position with the coupling element and the actuating element made use of. The first actuator controls the desired air distribution flow path so that one or several air outlets can be provided with conditioned air at the same time. The second actuator, however, controls the hot and cold air proportions to obtain the desired air outlet temperature. The hot and cold air proportions vary dependent on the position of the second actuator used to control the air temperature.

Particularly characteristic of the invention is the actuating element positionable between two end stops in steps or, preferably, steplessly, whereby each position taken by the actuating element corresponds to both a position of the second actuator to control the air temperature and a position of the first actuator to release at least one flow path assigned to one or several air outlet(s). At least two different positions of the actuating element the air prepared by the heating and air conditioning device with a different temperature is directable to different locations, or air outlets of the vehicle. Further, by different positioning of the actuating element, first, conditioned air can be directed to the air outlets for the windscreen, the instrument panel and the footwell or combinations thereof at the same time. But one and the same air outlet can also be supplied with differently tempered air for two different positions of the actuating element.

The actuating element and the second actuator each have, preferably, a nonlinear characteristics so that there is no proportional variation of the air outlet temperature or the blended air temperature controlled by the first actuator with the position of the actuating element.

So the control unit for the control of the heating and air conditioning units just includes only a control element for the fan, a control element for switching-on/switching-off the air conditioning unit as well as only one single actuating element configured as control element for the control of the combined air blending and air distribution actuating unit. For this purpose, said actuating element can be configured as rotary knob, slide control or push button.

The significant advantages and features of the invention over prior art essentially are:
The first actuator to release an air distribution flow path and the second actuator to release a blended air flow path are in functional connection to each other by means of a coupling element.
For the control of the air blending and air distribution actuating unit, a mechanical or electrical actuating element with a coupling unit is provided, which is engaged with either one of the two actuators or the coupling element.
Both the temperature and the air distribution can be controlled on the air side by means of only one single actuating element.
At least two different positions of the actuating element the conditioned air having a different temperature is directable to different places, or air outlets of the vehicle.
One and the same air outlet can also be supplied with differently tempered air for two different positions of the actuating element.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is the control unit with the actuating element configured as control element;

FIG. 2 is the course of the characteristic of the second actuator to release a blended air flow path and the characteristic of the actuating element;

FIG. 3 is the coupling element configured as closed-track cam drive in functional connection to the first actuator and the second actuator;

FIG. 4 is the heating and air conditioning device with the closed-track cam drive; and

FIG. 5 is the cross-section of the heating and air conditioning device.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

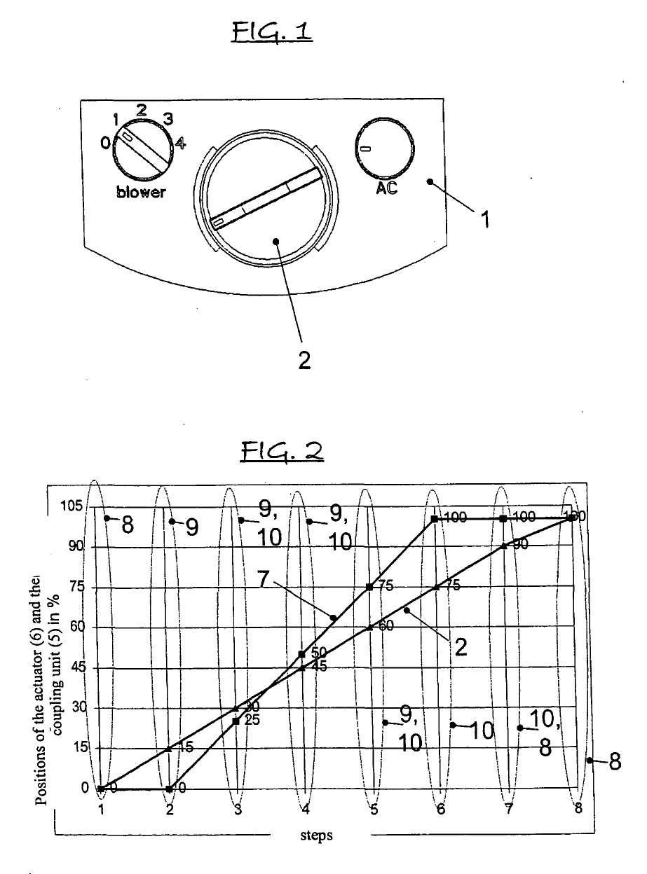

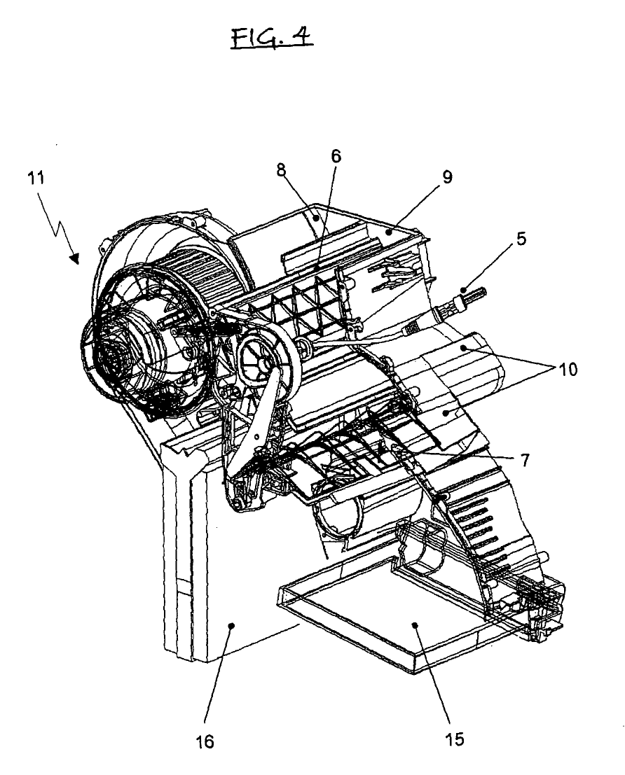

FIG. 1 shows the control unit 1 with the actuating element 2 configured as control element. The actuating element 2 centrally placed in the control unit 1 is adjustable, or positionable, respectively, steplessly between 0% and 100%. Hereby, the value of 0%—seen left by the viewer—corresponds to maximum “cold”, the value of 100%—seen right by the viewer—corresponds to maximum “hot”. For the value of 0%, having made use of the second actuator 7 according to FIG. 3, the cold air flow path 3 shown in FIG. 5 is totally open and the hot air flow path 4 shown in FIG. 5 is totally closed. But for the value of 100%, having made use of the second actuator 7 the hot air flow path 4 is totally open and cold air flow path 3 totally closed.

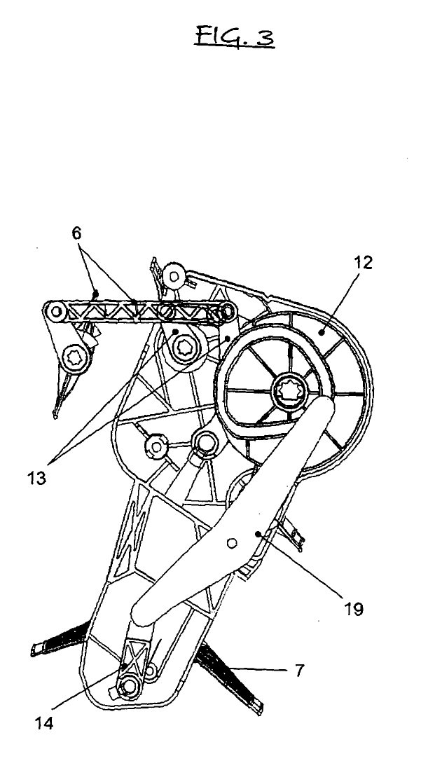

FIG. 2 shows the course of the characteristic of the second actuator 7 to release a blended air flow path and the characteristic of the actuating element 2 in a common diagram. The actuating element 2 and the second actuator 7 each have, preferably, a nonlinear characteristic so that there is no proportional variation of the blend air temperature controlled by the second actuator 7 with the position of the actuating element 2. In the example shown the actuating element 2 is stepped 0%, 15%, 30%, 45%, 60%, 75%, 90% and 100%.

First, a definable position of the second actuator 7 according to FIG. 3 and hence, a definable temperature value is assigned to each of these eight steps, whereby the above mentioned nonlinear dependence exists between the stepping of the actuating element 2 and the position of the second actuator 7 to release a blended air flow path. In the example shown the second actuator 7 is stepped 0%, 0%, 25%, 50%, 75%, 100%, 100% and 100%. That means that at the first step of the actuating element 2 the hot air flow path 4 is totally closed; only cold air leaves the desired air outlet. At the sixth step, already the value 100% hot air proportion is assigned to the actuating element 2 with a value of 75%; the cold air flow path 3 according to FIG. 5 is already totally closed at this moment. Solely at the first step—between the third and forth steps and at the eighth step as well—the position of the actuating element 2 corresponds—considered relatively—to the position of the second actuator 7.

On the other side, to each step of the actuating element 2 one or several defined air outlets 8 to 10 according to FIG. 5 are assigned, each represented in the diagram by an ellipse with a dashed borderline. Actuating the actuating element 2 using the first actuator 6 shown in FIG. 3 releases different air distribution flow paths. As it is seen, in the example shown the flow paths for three different air outlets 8 to 10 are released. At each of the steps three, four, five and seven the first actuator 6 releases the flow paths for two different outlets 9, 10 or 8, 10, respectively. At the steps one and eight only the flow path to the air outlet for the windscreen 8 is released. The outlet for the instrument panel is marked with reference number 9, the outlet for the footwell is marked with reference number 10. According to the invention, by positioning the actuating element 2, first, one or several flow paths to different air outlets 8 to 10 are supplied making use of the first actuator 6, and, second, said flow paths are provided with different air temperatures making use of the second actuator 7. Also stepless adjustment of the actuating element 2 is possible.

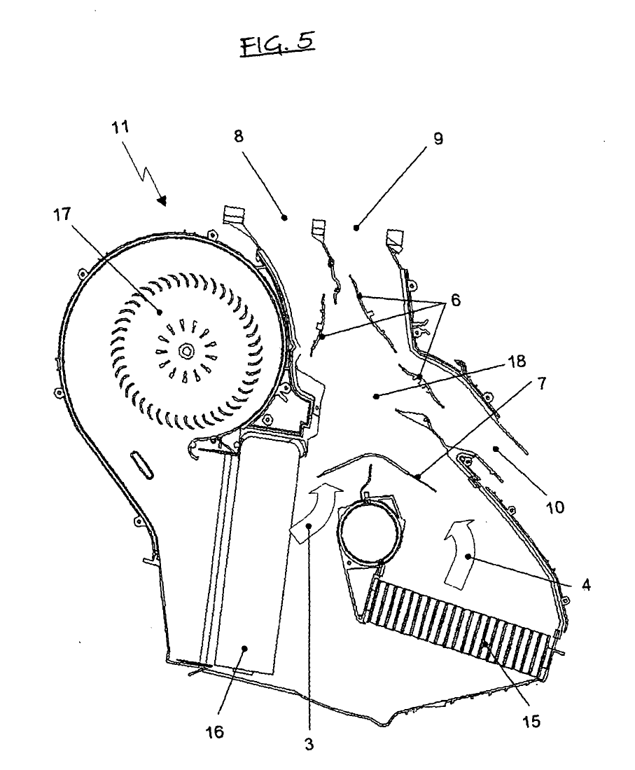

FIGS. 3 and 4 show the coupling element 12 configured as closed-track cam drive in functional connection to the first and second actuators 6, 7, and a complete representation of the invention in conjunction with the vehicle's heating and air conditioning device 11 equipped with an evaporator 16 and a radiator 15. The actuating element 2 shown in FIG. 1 is functionally connected to the coupling element 12 established as closed-track cam drive over the coupling unit 5 established as flexible drive shaft. The closed-track cam drive itself is provided with at least two tracks. A catching element, established as pin, of a first lever 13 [=lever for the first actuator] engages with a first track, whereby said first lever 13 is connected to the first actuator 6 to release an air distribution flow path. But with the second track, a catching element, established as pin, of a connecting element 19 engages. The connecting element 19 is coupled over a second lever 14 [=lever for the second actuator] to the second actuator 7 to release a blended air flow path such that the first actuator 6 together with the second actuator 7 is positioned through the coupling element 12. When the actuating element 2 is operated according to FIG. 1, the cam disc, by means of the coupling unit 5, is positioned through the coupling element 12, after which the positions of both actuators 6, 7 change by means of their appropriate levers 13, 14 and the connecting element 19. Hereby, the two tracks of the cam disc can be passed in same or opposite directions by the pin-like catching elements. Positioning of the first actuator 6 to release an air distribution flow path causes one or several air outlets 8, 9 and 10 to be supplied with conditioned air.

FIG. 5 illustrates a cross-section of the heating and air conditioning device 11. The heating and air conditioning device 11 includes a casing wherein a fan 17, an evaporator 16 and a radiator 15 as air conditioning devices are placed. The air to be conditioned is fed to the radiator 15 and the evaporator 16 by the fan 17, whereby the proportions of heated and cooled air vary according to the position of the second actuator 7. The cold air flow path 3, which starting from the evaporator 16 extends up to the second actuator 7, and the hot air flow path 4, which starting from the radiator 15 extends up to the second actuator 7, join right after the second actuator 7 to form the blended air flow path in the air blending room 18. Downstream of the air blending room 18, the first actuator 6 to release an air distribution flow path is located. The first actuator 6 and the second actuator 7 are connected by means of the coupling element 12 shown in FIG. 3 in such a way that adjustment of one of the two actuators 6, 7 causes adjustment of the respective other actuator 6, 7. The first actuator 6 releases, according to the position thereof, one or several air outlets 8 to 10 supplied with conditioned air.

From the foregoing description, one ordinarily skilled in the art can easily ascertain the essential characteristics of this invention and, without departing from the spirit and scope thereof, can make various changes and modifications to the invention to adapt it to various usages and conditions.

### NOMENCLATURE

1 control unit
2 actuating unit
3 cold air flow path
4 hot air flow path
5 coupling unit
6 first actuator
7 second actuator
8 air outlet windscreen
9 air outlet instrument panel
10 air outlet footwell
11 heating and air conditioning device
12 coupling element
13 lever for first actuator
14 lever for second actuator
15 radiator
16 evaporator
17 fan
18 air blending chamber
19 connecting element

What is claimed is:

1. An actuating unit for selectively blending and distributing air from a heating and air conditioning system of a motor vehicle wherein the heating and air conditioning system produces a conditioned air flow, the actuating unit comprising:
an actuating element provided in a passenger component of the motor vehicle;
a coupling element associated with the heating and air conditioning system, the coupling element adapted to be controlled by the actuating element to control blending and distribution of air in the heating and air conditioning system; and
a plurality of actuators functionally connected to the coupling element and adapted to be selectively positioned by the coupling element to open and close a plurality of air flow paths within the heating and air conditioning system.

2. The actuating unit according to claim 1 wherein the plurality of actuators include:
at least one first actuator adapted to selectively control the distribution of the conditioned air to the motor vehicle;
at least one second actuator adapted to selectively control blending of heated air and cooled air from the heating and air conditioning system prior to the heated air the cooled air being distributed to the motor vehicle by the first actuators.

3. The actuating unit according to claim 2 wherein the first actuator and the second actuator are pivoting doors that can be selectively positioned to open, close, and partially restrict the air flow paths within the heating and air conditioning system.

4. The actuating unit according to claim 1 wherein the coupling element is a gear, the gear including at least one closed-track cam drive disposed thereon.

5. The actuating unit according to claim 4 wherein the first actuator is functionally connected to the coupling element by at least one lever in communication with the closed-track cam, and the second actuator is functionally connected to the coupling element by at least one lever and at least one connecting element in communication with the closed-track cam, the lever and the connecting element adapted to manipulate the first actuator and the second actuator upon a rotational movement of the coupling element.

6. The actuating unit according to claim 5 wherein the rotational movement of the coupling element separately manipulates the first actuator and the second actuator.

7. The actuating unit according to claim 1 wherein the coupling element is in electrical communication with the actuating element.

8. The actuating unit according to claim 1 wherein the coupling element is in mechanical communication with the actuating element.

9. The actuating unit according to claim 2 wherein the actuating element is selectively positionable between a first stop and a second stop, each position of the actuating element therebetween corresponds to both a position of the first actuator to distribute air to the motor vehicle, and a position of the second actuator to blend the heated air and the cooled air to a desired temperature.

10. The actuating unit according to claim 2 wherein at least two different positions of the actuating element provide a different blend of the heated air and the cooled air and distribute the blended air to different air flow paths within the heating and air conditioning system.

11. The actuating unit according to claim 1 wherein the actuating element is configured as a rotary knob.

12. The actuating unit according to claim 1 wherein the actuating element is configured as a slide control.

13. The actuating unit according to claim 1 wherein the actuating element is configured as a push button.
